(19) United States
(12) Patent Application Publication
(10) Pub. No.: US 2005/0051193 A1
(43) Pub. Date: Mar. 10, 2005

(54) Compressed air gutter cleaning system

(76) Inventor: David L. Duke, Ripon, CA (US)

Correspondence Address: CHRISTIE, PARKER & HALE, LLP, PO BOX 7068, PASADENA, CA, 91109-7068, US

(21) Appl. No.: 10/936,855

(22) Filed: Sep. 9, 2004

Related U.S. Application Data
(60) Provisional application No. 60/501,085, filed on Sep. 9, 2003.

(51) Int. Cl. B08B 7/04

(52) U.S. Cl. 134/17; 134/22.18; 134/37; 134/172; 134/198

(57) ABSTRACT

A system and method for cleaning a gutter for channeling liquid toward a downspout, when the gutter is substantially dry. The system includes an air compressor for in-taking and compressing air to output as compressed air, a hose for channeling the compressed air to the gutter, the hose having a first end and a second end, the first end being connected to the air compressor to receive the compressed air therefrom; and a wand having a first end and a second end, the first end being connected to the second end of the hose for receiving the compressor air from the hose and for directing a flow of the compressed air toward its second end to apply the compressed air to the gutter.

### CROSS-REFERENCE TO RELATED APPLICATION

This application claims priority to and the benefit of U.S. Provisional Patent Application No. 60/501,085 entitled “‘Gutterblast’ Compressed Air Gutter Cleaning System” filed Sep. 9, 2003, the entire contents of which are incorporated herein by reference.

### FIELD OF THE INVENTION

The present invention relates generally to a system and method for cleaning gutters, and particularly to a system and method utilizing compressed air for cleaning gutters and to the system for minimizing clogging of the opening of a downspout.

### BACKGROUND

Many present-day commercial and residential buildings have gutters. A gutter is a channel or a through which usually runs along a side of a building roof or the eaves and is designed to channel rainwater from the roof to the downspout. The downspout, usually a vertical pipe, carries the rainwater down to the ground or other water-run-off system. There are various shapes and designs of gutters and downspouts. Dead leaves, dirt, debris, bird droppings, rocks, and other matter often collect in the gutter, clogging it and thereby reducing gutter's ability to channel water. Thus, gutters must be periodically cleaned.

A number of methods for cleaning gutters are presently known. There are hand-held debris scoopers, over-head water jet wands, and non-compressed air blower extensions. In addition, a number of plastic and metal standardized fabricated downspout screens have been used to promote continued water flow to the downspout by preventing collection of leaves and other debris over the downspout opening.

These conventional gutter cleaning methods, however, are highly labor intensive, time consuming and do not easily lend themselves to high volume commercial cleaning business application. These conventional gutter cleaning tools and processes cannot efficiently clean gutters which are of all shapes, sizes, and relative location with respect to roofing and architecture. While these conventional devices may be suitable for the particular purpose/gutter for which they are designed, they are usually not as suitable for cleaning both commercial and residential gutters or protecting the opening to the gutter downspout from clogging.

Therefore, it is desirable to provide a gutter-cleaning system and/or method that is less labor intensive, is flexible in its application to differently shaped gutters, and is able to work with both residential and commercial gutters. It is further desirable to provide a method for reducing future clogging of the opening to the downspout. It is likewise desirable to provide a gutter cleaning system that is capable of efficiently cleaning the gutter, regardless of gutter dimensions, thereby creating a commercially and financially viable gutter cleaning process.

The present invention provides a gutter cleaning system utilizing compressed air, various embodiments of which overcome one or more of the drawbacks of the conventional gutter cleaning systems.

### SUMMARY OF THE INVENTION

The present invention relates to a system for cleaning gutters including an air compressor, a hose and a wand. In further embodiments, the gutter system of the present invention may further include a nozzle for the wand. The present invention further relates to a screen for minimizing clogging of a downspout placed over an opening of the downspout. A method for cleaning gutters utilizing compressed air is also provided.

In an exemplary embodiment according to the present invention, is provided a system for cleaning a gutter for channeling liquid toward a downspout when the gutter is substantially dry. The system includes an air compressor for in-taking and compressing air to output as compressed air, a hose for channeling the compressed air to the gutter, the hose having a first end and a second end, the first end being connected to the air compressor to receive the compressed air therefrom, and a wand having a first end and a second end, the first end being connected to the second end of the hose for receiving the compressor air from the hose and for directing a flow of the compressed air toward its second end for application to the gutter.

In another exemplary embodiment according to the present invention, a method of cleaning a substantially dry gutter is provided. The method includes generating compressed air using a air compressor which takes in air to generate and output the compressed air, channeling the compressed air through a hose having a first end connected to the air compressed and a second end, and guiding the compressed air through a wand having a first end connected to the second end of the hose and a second end used to apply the compressed air to the gutter.

Various features and aspects of the present invention will be more readily comprehended in view of the discussion herein and accompanying drawings, in which like reference numerals designate like elements.

### BRIEF DESCRIPTION OF THE DRAWINGS

FIG. 1a is a diagram of a gutter cleaning system according to an exemplary embodiment of the present invention.

FIG. 1b is a bird's eye view of a roof to which the gutter cleaning system of FIG. 1a can be applied.

FIG. 2 is an elevated prospective view of the gutter cleaning system according to an exemplary embodiment of the present invention illustrating the gutter cleaning system with a nozzle.

FIG. 3 is a diagram of a gutter cleaning system according to another exemplary embodiment of the present invention showing various wands and nozzles.

FIG. 4 is a diagram of the downspout screen in use according to one embodiment of the present invention.

### DETAILED DESCRIPTION

In the following detailed description, only certain exemplary embodiments of the present invention are shown and described, simply by way of illustration. As those skilled in the art would realize, the described exemplary embodiments may be modified in various different ways, all without departing from the spirit or scope of the present invention. Accordingly, the drawings and description are to be regarded as illustrative in nature, and not restrictive.

The compressed air gutter cleaning system, according to an exemplary embodiment of the present invention, includes an air compressor, an air hose, and one or more of an assortment of air wands and nozzles. In a further exemplary embodiment, a custom-designed wire downspout screen is also provided. The air compressor, mounted or affixed to a bed of a small truck, is connected by a long plastic or rubber hose to a wand and nozzle. The pressurized air from the air compressor is conducted through the hose and directed by the wand or the nozzle with sufficient force to clear at least some debris from the gutter being cleaned. The pressurized air may completely remove the debris from the gutter, leaving the gutter completely clean or free of debris. The wire downspout screen is designed to fit over the opening of the particular downspout and in the gutter being serviced.

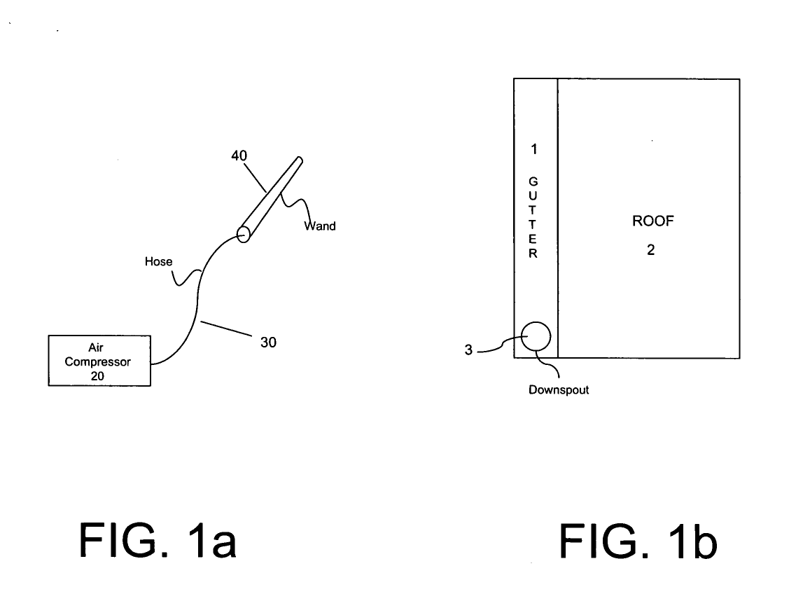

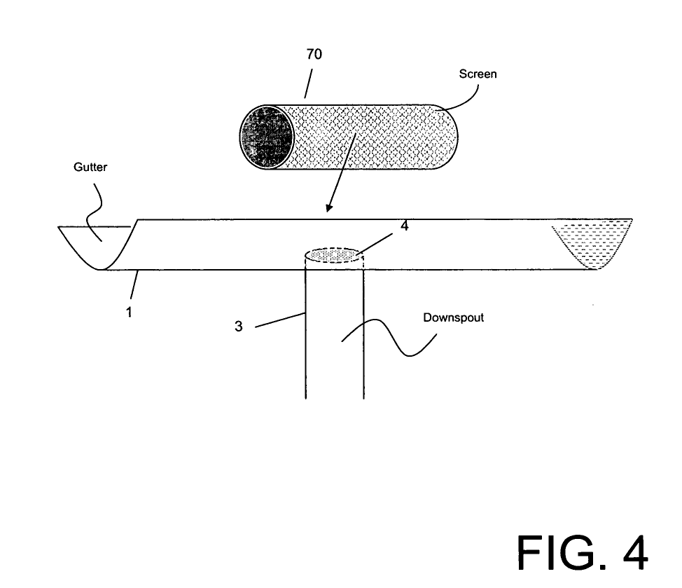

FIG. 1a shows a gutter cleaning system according to an exemplary embodiment of the present invention. In the bird's eye view of FIG. 1b, a gutter 1 is attached or mounted to a building roof 2. The gutter and downspout draining systems are generally known in the art, and no specific construction of the gutter is required. The system for cleaning the gutter 1 according to an exemplary embodiment of the present invention contains an air compressor 20, an air hose 30 attached to the air compressor, and at least one wand 40. In a further embodiment, a custom wire mesh screen 70 (shown in FIG. 4) is provided for placement over the opening of the downspout 3.

The air compressor 20 is a commercial grade air compressor with a relatively high foot pound and a relatively high volume. The air compressor 20 produces compressed air, which is air at a pressure greater than that of the atmosphere. In the exemplary embodiment of FIG. 1a, the volume of air delivered by the air compressor is 10 to 40 cubic feet per minute (“cfm”) (equivalent to 0.28 to 1.13 cubic meter per minute “m3/min”) and the amount of pressure that the air compressor is able to develop is 50 to 250 pounds per square inch (“psi”) (equivalent to 3.52 to 17.58 kilogram-force per square centimeter “kgf/cm2”). Alternatively, the volume of the air delivered by the air compressor may 25 to 30 cfm (0.71 to 0.85 m3/min). For example, the air compressor 20 may be an air compressor manufactured by Champion, model number HGR5-LP.

Alternatively, any commercially available air compressor rated 1-1000 psi (0.07-70.31 kgf/cm2) at 1-1000 cfm (0.28-28.32 m3/min) may be used. For ease of use, in the exemplary embodiment of the invention, the air compressor 20 may be mounted or affixed to a bed of a small truck, such as a pickup truck. In an alternative embodiment, the air compressor may be a free-standing unit.

The pressurized air from the air compressor 20 is conducted through the hose 30. According to the exemplary embodiment of the present invention, the hose 30 is a plastic or a rubber air hose. It has a 250 to 500 psi rating, i.e. it is designed to withstand 250 to 500 pounds of pressure per square inch (or 17.58 to 35.15 kgf/cm2). The hose 30 may range, for example, from 10 feet to 1000 feet in length (or 3 to 305 meters).

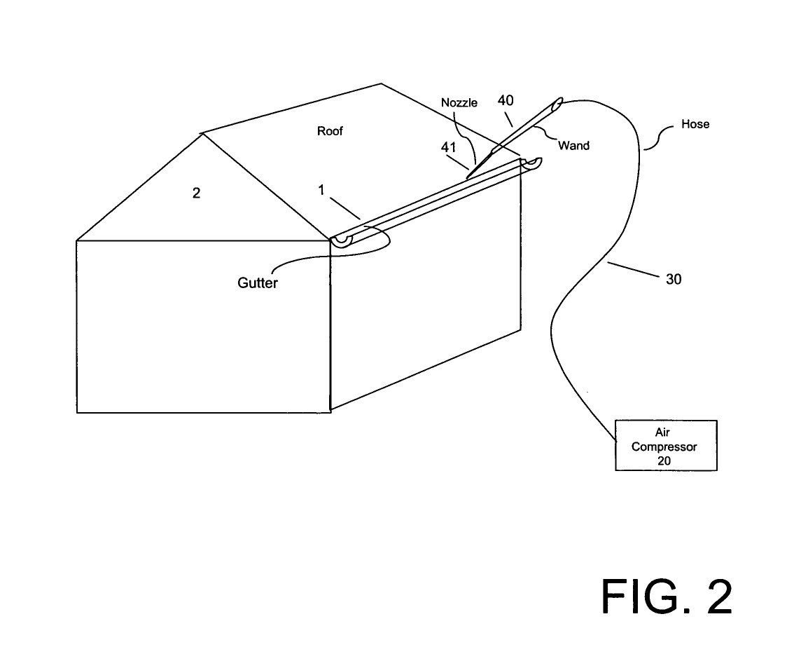

In other embodiments of the present invention, the hose 30 may be longer or shorter, or be of any suitable length depending on the application. The hose 30 should be long enough to allow the operator to easily manipulate the wand 40 or the nozzle 41 (shown in FIG. 2) in order to clean the gutter 1. In the exemplary embodiment of FIG. 1a, the hose 30 is ¼″ to ¾″ (0.64 to 1.91 cm) in diameter and is a commercially available plastic or rubber hose. Alternatively, any commercially available or suitable air hose may be used.

The pressurized air from the air compressor 20 conducted through the hose 30 is directed by the wand 40. In the exemplary embodiment of FIG. 1a, the wand 40 is an aluminum pole which may be 18 inches to 32 feet (45.7 cm to 9.75 m) in length. For example, a wand distributed by Harbor Freight Tools may be used. In other embodiments, any suitable wand may be used.

The wand 40 directs the “blast” of the compressed air toward the debris to be cleaned. The wand 40 is a pole or a tube constructed of light weight aluminum or similar material so as to allow for a single operator to manipulate the compressed air gutter cleaning system. The wand 40 may range from 18 inches to 32 feet (45.7 cm to 9.75 m) in length and from ¼ to 1/8 inches (0.64 to 0.32 cm) in diameter. In a further embodiment of the invention, the wand 40 may be 1/8 inches (0.32 cm) in diameter and made of aluminum or rubber and thus can be used for clearing downspouts, as such diameter would fit well within the opening of most downspouts.

In further embodiments of the present invention, the nozzle 41, shown in FIG. 2, can be fitted on to the wand 40 for further directing the outward flow of the pressurized air. A variety of nozzles may be utilized. For example, the ¼″ (0.64 cm) diameter wands can be equipped with a variety of replaceable tips or nozzles 41 which are commercially available from various hardware and tool stores. The nozzle 41 may be threaded at its widest end, so as to allow easier attachment to the wand 40. The nozzle 41 may be a fitted nozzle which fits over the wand 40 and may be of any commercially-available or custom shape. For example, the nozzle 41 may be a rubber tip manufactured by Amflo company, model number 202D, available from BradysTools company in Florida, USA. Auto shop air wands can also be used, however they are typically equipped with a hand held valve which can cause the operator's hand to get tired. In this manner, the tip of the wand 40 or the nozzle 41 may be customized to work with any particular shape or design of the gutter 1 and the downspout 3.

In a yet another embodiment of the present invention, the tip of the wand 30 furthest away from the air compressor 20 may be pinched or squeezed to form an opening of 1/16 to 1/4 inches (0.12 to 0.64 cm) in diameter. In this manner, a nozzle 41 may not be needed to direct airflow, and the “pinched” wand may be used instead.

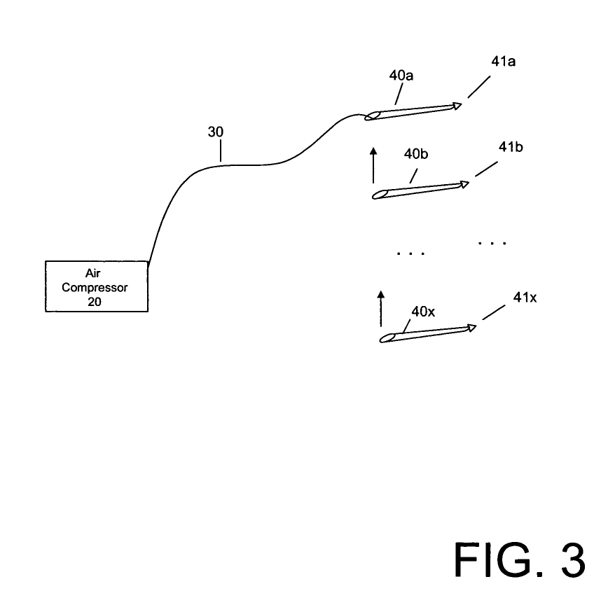

FIG. 3 shows another embodiment of the present invention, where the hose 30, connected to the air compressor 20, may be equipped with a variety of wands 40a-40x or wands and nozzles 41a-41x. The operator uses various wands and nozzles depending on the area of the gutter or the downspout he or she desires to clean. The varying wands 40a-40x may be utilized for cleaning the gutter and the downspout. Furthermore, the varying wands 40a-40x may be used for cleaning different residential and commercial gutters, allowing the operator to simply switch the nozzle or the wand while switching between various buildings with various gutters.

The compressed air gutter cleaning system of the exemplary embodiment described above operates by, first, the air compressor 20 pressurizing air. The pressurized air then travels through the hose 30 and is expelled through the wand 40 (or, in further embodiments described above, through the nozzle 41). The pressurized air from the air compressor 20, so conducted through the hose 30 and directed by the wand 40 or nozzle 41, is “blasted” with sufficient force to blow away at least some dry debris from the gutter 1. The operator points the wand 40 or the nozzle 41, directing pressurized air from the wand 40 or the nozzle 41 toward the debris to be cleared. The operator can be located on the roof 2, the ground, a ladder, or the like. Compressed air is directed through the wand 40 or nozzle 41 at any debris accumulated in the gutter, such as dirt, leaves, small rocks, bird droppings, or other debris, which is then blasted from the gutter.

It should be noted that for this process to work efficiently, the debris in the gutter being cleaned should be mostly or substantially dry, such that the debris will not be stuck together through moisture for example. For example, it is preferable that the gutter cleaning system of the present invention should not be used after a rain or when the debris inside the gutter is wet, as the wet debris (such as wet leaves, for example) weighs more than dry debris and might not lend itself to being blown away by the pressurized air. Therefore, it is desirable that the gutter cleaning system of the present invention be utilized when the debris inside the gutter is substantially dry or completely dry (“bone dry”).

Referring now to FIG. 4, in a further embodiment of the invention, accumulation of debris over the opening 4 of the downspout or in the downspout 3 is reduced by use of a screen 70 placed inside the gutter 1 over the opening of the downspout 3. Use of the screen 70 in this manner helps maintain water flow through the downspout 3 by preventing or reducing clogging of the downspout 3 and/or the downspout opening 4. The screen 70 is a custom-made wire mesh screen or any other suitable screen such as one made of chicken wire.

In the exemplary embodiment, the screen 70 is fabricated from a 1 sq. ft. (0.09 square meter) wire screen which is rolled into a custom-fitted cylinder and then placed horizontally over the downspout opening 4, inside the gutter. According to the exemplary embodiment, the wire mesh can range from a ¼″ to a 1½″ (0.64 to 3.81 cm) cut square of 4″ through 36″ (10.16 to 91.44 cm) length. In other embodiments, any manually pliable metal wire mesh can be utilized to construct the screen 70. As discussed above, gutters, as well as downspouts, can be of various shapes and sizes. Custom fabrication of the screen 70 allows the screen 70 to be fitted over the various shapes and sizes of the downspout and in the various shapes and sizes of gutters.

According to the exemplary embodiment of the invention, following the cleaning of the gutter utilizing the pressurized air system, the operator would place the screen 70 over the opening 4 of the downspout 3. Such screen 70 may be either pre-assembled or assembled on site by the operator. In other words, the operator may roll up the screen to form a generally cylindrical screen for placing it over the downspout or in the gutter. Once fitted into the gutter, the cylindrically rolled screen may, for example, may unroll so as to engage the inner surface of the gutter for tight fitting.

Although this invention has been described in certain exemplary embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive; the scope of the invention to be determined by the appended claims and the range of their equivalents.

1. A system for cleaning a gutter for channeling liquid toward a downspout when the gutter is substantially dry, the system comprising:
an air compressor for in-taking and compressing air to output as compressed air;
a hose for channeling the compressed air to the gutter, the hose having a first end and a second end, the first end being connected to the air compressor to receive the compressed air therefrom; and
a wand having a first end and a second end, the first end being connected to the second end of the hose for receiving the compressed air from the hose and for directing a flow of the compressed air toward its second end for application to the gutter.

2. The system of claim 1 wherein the compressed air has a pressure of 50 to 250 pounds per square inch.

3. The system of claim 2 wherein the air compressor supplies the compressed air at a volume of 10 to 40 cubic feet per minute

4. The system of claim 2 wherein the air compressor supplies the compressed air at a volume of 25 to 30 cubic feet per minute

5. The system of claim 1 wherein the hose has a rating of at least 250 pounds per square inch.

6. The system of claim 4 wherein the hose is 10 to 1000 feet long.

7. The system of claim 1 wherein the wand is an aluminum pole and is 18 inches to 32 feet long.

8. The system of claim 1 further comprising a nozzle attached to the second end of the wand for further directing the compressed air.

9. The system of claim 1 further comprising one or more wands connected to the air compressor and one or more nozzles attached to the one or more wands

10. The system of claim 1 further comprising a screen for reducing clogging of the downspout comprising a wire mesh rolled into a generally cylindrical form and placed in the gutter over an opening to the downspout.

11. A method of cleaning a substantially dry gutter comprising:
generating compressed air using a air compressor which takes in air to generate and output the compressed air;
channeling the compressed air through a hose having a first end connected to the air compressor and a second end; and
guiding the compressed air through a wand having a first end connected to the second end of the hose and a second end used to apply the compressed air to the gutter.

12. The method of claim 11, wherein said generating compressed air comprises generating the compressed air having a pressure of 50 to 250 pounds per square inch.

13. The method of claim 12 wherein said generating compressed air further comprises supplying the compressed air at a volume of 10 to 40 cubic feet per minute

14. The method of claim 12 wherein said generating compressed air further comprises supplying the compressed air at a volume of 25 to 30 cubic feet per minute

15. The method of claim 11 wherein the hose has a rating of at least 250 pounds per square inch.

16. The method of claim 15 wherein the hose is 10 to 1000 feet long.

17. The method of claim 11 wherein the wand is an aluminum pole and is 18 inches to 32 feet long.

18. The method of claim 11 further comprising directing the compressed air to the gutter through a nozzle attached to the second end of the wand.

19. The method of claim 11 further comprising:
rolling a wire mesh into a generally cylindrical form; and
placing the wire mesh in the gutter over an opening to the downspout such that the wire mesh forms a screen for reducing clogging of the downspout.
